(19) United States
(12) Patent Application Publication
(10) Pub. No.: US 2026/0058477 A1
(43) Pub. Date: Feb. 26, 2026

(54) ISOLATED HYBRID PLANT

(71) Applicant: Wobben Properties GmbH, Aurich (DE)

(72) Inventor: Eckard QUITMANN, Bremen (DE)

(73) Assignee: Wobben Properties GmbH, Aurich (DE)

(21) Appl. No.: 19/103,983

(22) PCT Filed: Jun. 27, 2023
(86) PCT No.: PCT/EP2023/067420

§ 371 Date: Feb. 14, 2025

(30) Foreign Application Priority Data
Aug. 17, 2022 (EP) 22190840.3

(51) Int. Cl. H02J 3/46; C25B 9/65; H02J 3/00; H02J 3/06

(52) U.S. Cl. CPC H02J 3/46; C25B 9/65; H02J 3/001; H02J 3/06; H02J 2300/28

(57) ABSTRACT

In one aspect, an electrical grid for an isolated hybrid power plant includes a first grid section configured to be connected to at least one wind power installation, be connected to at least one gas production installation, and transport an electrical power generated by the wind power installation to the at least one gas production installation; a second grid section configured to be connected to the at least one gas production installation; and a grid converter configured to electrically connect the first grid section and the second grid section to one another and bidirectionally exchange electrical power between the first electrical grid section and the second electrical grid section.

### TECHNICAL FIELD

The present disclosure relates to an electrical grid for a hybrid power plant and to a hybrid power plant of this type.

### BACKGROUND

Hybrid power plants, or hybrid plants, are a form of power plant used to produce electrical energy, fuel and/or heat from various primary energy sources.

A known example of hybrid power plants, or hybrid plants, of this type is so-called wind-based power-to-gas installations (P2G for short), which produce gas from wind power, for example.

The wind power installations first convert the kinetic energy of the wind, also called wind power, into electrical energy. This electrical energy is then supplied to electrolyzers in order to produce gas from it.

The gas obtained in this way can then be transferred to a gas grid, for example by means of a pipeline, or converted into another material, such as methane or kerosene, by means of synthesis and then transported away by ship.

A disadvantage of wind-based power-to-gas installations is the volatile wind and the accompanying fluctuating generation of electrical energy by the wind power installations.

The (sometimes heavily) fluctuating electrical power resulting from the volatility of the wind results not only in fluctuating production of gas but also in malfunctions within the gas production installations. To counteract this, over dimensioned electrical stores and sophisticated control strategies are usually used, which are extremely cost intensive.

### SUMMARY

The object of the present disclosure is therefore to address at least one of the aforementioned problems. In one example, the aim is to propose an electrical grid and/or a hybrid power plant that permits gas, liquid, fuel or the like to be produced at optimum cost, and in some examples, in consideration of grid problems within a power-to-gas installation and/or at sites remote from the supply grid.

The present disclosure therefore proposes an electrical grid, in one example for an isolated hybrid power plant, comprising a first grid section, which is configured to be connected to at least one wind power installation, to be connected to at least one gas production installation, and to transport an electrical power generated by the wind power installation to the at least one gas production installation; a second grid section, which is configured to be connected to the at least one gas production installation; and a grid converter, which electrically connects the first grid section and the second grid section to one another and is configured to bidirectionally exchange electrical power between the first electrical grid section and the second electrical grid section, wherein the first grid section has a first system rated frequency and a first system rated voltage and can be operated at a first system frequency and a first system voltage; and the second grid section has a second system rated frequency and a second system rated voltage and can be operated at a second system frequency and a second system voltage; and wherein the first grid section is designed for a first frequency range around the system rated frequency, in which the first system frequency varies; and the second grid section is designed for a second frequency range around the system rated frequency, in which the second system frequency varies; wherein the first frequency range is higher than the second frequency range.

Thus, in one example an electrical grid for a hybrid power plant, or a hybrid plant, is proposed that has two grid sections, which are different, or can be operated differently. In one example, it is proposed that the electrical grid has a first grid section having a wide frequency range, on which the actual power electronics for power transportation can be arranged, and a second grid section having a narrow frequency range, on which voltage-and/or frequency-sensitive auxiliary devices can be arranged, for example the control systems of the gas production installations.

The first grid section, which is responsible for the actual power transportation, thus has a much more flexible system frequency than the second grid section, which is responsible for supplying power to the voltage-and/or frequency-sensitive auxiliary devices of the gas production installations.

Thus, in one example an electrical grid for a hybrid power plant is proposed in which as little action as possible is taken in the first grid section. The first grid section thus has in one example a frequency range in which it is effectively possible for the system frequency to float freely (free-floating system frequency).

A design of this type having two different grid sections, which are in one example connected to one another via a grid converter, delivers an electrical grid that is much more robust and less expensive for isolated hybrid power plants than electrical grids known and used hitherto for that purpose, which normally have only one grid section.

An electrical grid is understood herein to mean in one example an electrical network for transmitting and distributing electrical energy. In one example, the electrical grid is in the form of an AC system, such as in the form of a three-phase AC system, and has two, and in some examples, different, grid sections.

The first grid section is, in one example, in the form of a three-phase AC system and/or is configured to be connected to at least one wind power installation, for example via a transformer. The first grid section is thus in one example configured to aggregate electrical energy that has been generated by a multiplicity of wind power installations. Moreover, the first grid section is configured to be connected to at least one gas production installation, for example via another transformer and a rectifier.

In one example, the first grid section is designed for power transportation, or power transmission, between wind power installations and gas production installations. The first grid section is thus in one example designed and/or intended to transport the electrical power generated by the wind power installations to the gas production installations so that said gas production installations convert the electrical power into gas.

In one example, the first grid section is designed for a rated power of at least 100 MW or more. This also means in one example that the individual electrical equipment items of the first grid section, for example transformers, cables, circuit breakers and the like, are designed for correspondingly high currents.

The second grid section is, in one example, in the form of a three-phase AC system and/or in one example configured to be connected to at least one, voltage-and/or frequency-sensitive, auxiliary device of the gas production installation, for example via a converter and/or a rectifier.

In one example, the second grid section is designed for supplying power to auxiliary devices, in one example voltage-and/or frequency-sensitive auxiliary devices of the gas production installations.

In one example, the second grid section is designed for a rated power of up to 20 MW. This also means in one example that the individual electrical equipment items of the second grid section, for example fuses, cables and the like, are designed for correspondingly high currents.

The wind power installations are thus in one example arranged on, or connected to, only the first grid section and/or not the second grid section. In one example, the first grid section is of much more powerful design than the second grid section, for example by a factor of between 10 and 100. The first grid section is thus in one example designed for a higher rated power than the second grid section. By way of example, the rated power of all the wind power installations of the isolated hybrid power plant that are connected to the first grid section is approximately 200 MW or more, and the total power of all the auxiliary devices of the hybrid power plant that are connected to the second grid section is approximately 20 MW or less.

Both the first grid section and the second grid section each have a system rated frequency. In one example, the first grid section has a first system rated frequency and the second grid section has a second system rated frequency.

The system rated frequency indicates in one example the frequency for which an electrical grid, or a grid section, is designed, or the approximate, or desired, frequency at which the electrical grid, or the grid section, is intended to be operated.

In one example, the first system rated frequency and/or the second system rated frequency are/is substantially approximately 50 Hz or approximately 60 Hz.

In one embodiment, the first grid section and the second grid section have substantially the same system rated frequency. By way of example, the first system rated frequency is 50 Hz and the second system rated frequency is also 50 Hz. In another embodiment, the first grid section and the second grid section have different system rated frequencies. By way of example, the first system rated frequency is 60 Hz and the second system rated frequency is 50 Hz, or vice versa.

Both the first grid section and the second grid section are each operated at a system frequency. The system frequency varies over time by the value of the system rated frequency. The system frequency can also be referred to as the system actual frequency or as the operative system frequency.

The system frequency indicates in one example the frequency that an electrical grid, or a grid section, has at a specific time.

According to one embodiment, it is now proposed that the system frequency of the first grid section can fluctuate much more sharply around the value of the first system rated frequency than the system frequency of the second grid section around the value of the second system rated frequency.

In one example, the first grid section and the second grid section each have a frequency range around the system rated frequency in which the system frequency can vary substantially freely. The grid sections are thus in one example designed, or operated, such that any protective devices, such as circuit breakers, trip only when the system frequency leaves the frequency range.

The frequency range of the first grid section is much larger than the frequency range of the second grid section. By way of example, the frequency range of the first grid section is 10 percent of the value of the first system rated frequency and the frequency range of the second grid section is 1 percent of the value of the second system rated frequency. In that case, the system frequency of the first grid section can vary freely between 47.5 Hz and 52.5 Hz when the system rated frequency is 50 Hz, for example, and the system frequency of the second grid section can vary freely only between 49.75 Hz and 50.25 Hz when the system rated frequency is 50 Hz, for example. In one example, the system frequency of the first grid section and/or of the second grid section is, in one example actively, regulated only when the system frequency leaves the frequency range, for example as a result of load connection and/or load shedding.

It is thus in one example also proposed that the system frequency within the first grid section and/or the second grid section is adjusted by means of open-loop power control or closed-loop power control, in one example such that the system frequency is within the frequency range. Only when the system frequency moves out of the frequency range is action actively taken in the closed-loop power control of the grid section, for example by restricting the wind power installations and/or the gas production installations.

Both the first grid section and the second grid section each have a system rated voltage.

The system rated voltage indicates in one example the voltage for which an electrical grid, or a grid section, is designed, or the approximate, or desired, voltage at which the electrical grid, or the grid section, is intended to be operated.

In one example, the first grid section has a first system rated voltage and the second grid section has a second system rated voltage. In one example, the first system rated voltage and/or the second system rated voltage are/is between 230 V and 20 kV.

In one embodiment, the first grid section and the second grid section have substantially the same system rated voltage. In a preferred embodiment, the first grid section and the second grid section have different system rated voltages. In one example, the first system rated voltage is higher than the second system rated voltage.

Both the first grid section and the second grid section are each operated at a system voltage.

The system voltage varies over time by the value of the system rated voltage. The system voltage can also be referred to as the system actual voltage or as the operative system voltage. The system voltage indicates in one example the voltage that an electrical grid, or a grid section, has at a specific time.

According to one embodiment, it is now proposed that the system voltage of the first grid section can fluctuate much more sharply around the value of the first system rated voltage than the system voltage of the second grid section around the value of the second system rated voltage.

The first grid section and the second grid section are furthermore electrically connected to one another, in one example via a grid converter or the like.

The grid converter is thus configured to electrically connect the first grid section and the second grid section to one another such that electrical power can be exchanged between the first grid section and the second grid section.

In one example, the first grid section and the second grid section are connected to one another via a bidirectional grid converter, in one example such that electrical power can be shifted from the first grid section to the second grid section and electrical power can be shifted from the second grid section to the first grid section, for example by means of appropriate control for the electrical grid.

The electrical grid, that is to say the first grid section and/or the second grid section, may also be connected to and/or have other electrical components, for example electrical stores, transformers or the like.

In one example, the first grid section has a first rated power and the second grid section has a second rated power, wherein the first rated power is higher than the second rated power, which in one example is at least 5 times as high, and in another example at least 10 times as high.

Since the first grid section is intended for transporting power between wind power installations and gas production installations, the first grid section is of much larger design than the second grid section. This relates in one example to all of the power electronics of the respective grid section. By way of example, the first grid section has a rated power of 200 MW or more and the second grid section has a rated power of 20 MW or less.

In one example, the first frequency range is equal to and/or less than 20 percent, in another example equal to and/or less than 10 percent, and in another example equal to and/or less than 5 percent, of the first system rated frequency and/or the second frequency range is equal to and/or less than 2 percent in one example, or equal to and/or less than 1 percent in another example, of the second system rated frequency.

The first frequency range and/or the second frequency range can therefore be stipulated on the basis of the system rated frequency of the respective grid section.

By way of example, the system rated frequency of the first grid section is 50 Hz and the first frequency range of the first grid section is 20 percent thereof, that is to say 10 Hz. The first system frequency can then vary substantially freely in a frequency range between 40 Hz and 60 Hz, for example.

The second frequency range, that is to say the frequency range of the second grid section, on the other hand, is chosen to be much narrower than the first frequency range, for example 0.2 Hz. The second system frequency can then vary substantially freely between 49.9 Hz and 50.1 Hz.

In one example, it is proposed that the first grid section is operated with a wide frequency range, such as with a wider frequency range than usual, and/or that the second system frequency in the second grid section can vary only minimally around the second system rated frequency, such that voltage-and/or frequency-sensitive means can also be connected to the second grid section.

This can in one example ensure that the voltage-and/or frequency-sensitive auxiliary devices can be reliably supplied with power by the second grid section. In order to keep the system frequency in the applicable frequency ranges, various mechanisms can be put in place, for example specific schedules, statics or the like. In one example, at least closed-loop power control is used to keep the system frequency in the frequency range.

In one example, the second grid section is prepared to supply voltage-and/or frequency-sensitive auxiliary devices, of installations such as the gas production installations, with electrical power in a voltage-and/or frequency-stable manner.

It is thus, in one example, proposed that the voltage- and/or frequency-sensitive auxiliary devices of the gas production installations are arranged on a separate grid section that exhibits substantially greater voltage stability and frequency stability. The second grid section has appropriate means and/or connections for this, for example. The means are in one example used to keep the voltage and/or the frequency in the second grid section stable. By way of example, the means may be a voltage measurement system, a frequency measurement system, a closed-loop power control system, an electrical store or the like. In one example, the second grid section has at least one connection for, or an electrical store, that is configured to keep the system frequency in the second grid section stable by supplying real power and/or extracting real power and/or to keep the voltage in the second system voltage in the second grid section stable by supplying reactive power and/or extracting reactive power.

In one example, the grid converter is configured to exchange (e.g., bidirectionally), electrical power between the first grid section and the second grid section.

For this purpose, the grid converter may be in the form of a bidirectional frequency converter, for example.

The grid converter is thus in one example configured to shift an electrical power from the first grid section to the second grid section and/or to shift an electrical power from the second grid section to the first grid section. In one example, the grid converter is configured to extract electrical real power and/or reactive power from the first grid section and/or to supply said power to the first grid section and/or to extract electrical real power and/or reactive power from the second grid section and/or to supply said power to the second grid section. The grid converter is thus in one example configured to operate in a 4-quadrant mode.

Alternatively or additionally, the grid converter is configured to form a grid former for the first grid section and/or the second grid section and/or to impress a voltage into the first grid section and/or the second grid section.

The grid converter is thus, in one example, in the form of a voltage-impressing, such as AC-voltage-impressing, converter and configured to operate in a voltage-impressing manner, or to impress a voltage into the first grid section and/or the second grid section. The grid converter can thus in one example be actuated such that it behaves approximately like an ideal voltage source.

Grid former, or voltage-impressing, with regard to the grid converter means in one example that the grid converter is configured:
1) to impress a sinusoidal, such as three-phase, AC voltage, and in one example, at a specified frequency, into a grid section, which can be largely irrespective of the load in the grid section, and/or
2) to deliver an undelayed real power and/or reactive power for a grid section that causes the system voltage and/or the system frequency in the grid section to be kept largely constant, and/or
3) to form a low-impedance sink for all disturbances in a grid section, and/or
4) to deliver a high short-circuit power for a grid section.

Alternatively or additionally, the grid converter is configured to stabilize the system voltage and/or the system frequency in the first grid section and/or in the second grid section.

This can be accomplished for example as a result of the grid converter extracting and/or supplying electrical real power and/or electrical reactive power from/to the first grid section and/or the second grid section.

The grid converter may also be configured by means of a control unit to form a STATCOM or a phase shifter for the first grid section and/or the second grid section.

Alternatively or additionally, the grid converter is configured to deliver a stable second system frequency and/or a stable second system voltage in the second grid section, and in one example for voltage-and/or frequency-sensitive auxiliary devices.

For this purpose, the grid converter measures the second system frequency and/or the second system voltage, for example, and delivers relevant real power and/or reactive power in the second grid section, which result in a stable system frequency and/or a stable system voltage in the second grid section. In one example, the grid converter is configured to keep both the system frequency and the system voltage in the second grid section stable.

Alternatively or additionally, the grid converter is configured to impress a system voltage into the second grid section.

The grid converter is thus in one example configured to form a voltage-impressing converter for the second grid section.

Alternatively or additionally, the grid converter is configured to deliver a short-circuit power for the first grid section and/or the second grid section, and in one example when a disturbance occurs in the first grid section and/or in the second grid section.

In one example, the electrical grid is electrically independent or isolated.

This means in one example that the electrical grid is not connected to an electrical distribution grid or interconnected system, for example the European interconnected system. Instead, the electrical grid is in the form of an isolated system. This also means in one example that the system voltage and/or the system frequency within the electrical grid need/s to be regulated independently, for example by using a grid former that impresses a specific voltage into the electrical grid, or the first or second grid section.

Nevertheless, the electrical grid may be connected to smaller electrical grids, that is to say systems that have a lower system rated power and/or system rated voltage, for example the electrical grid of a harbor where the gas produced by the hybrid power plant described herein is shipped.

The electrical grid is thus in one example not connected to an electrical supply grid or interconnected system or another electrical distribution grid that has the same or a higher system rated power.

In one example, the first grid section is not connected to another electrical distribution grid and/or an electrical supply grid or interconnected system. The first grid section thus has essentially only the wind power installations, the gas production installations and the grid converter connected to it.

In one example, the first grid section and/or the second grid section is in radial or ring form.

It is thus in one example also proposed that relevant system topologies that take into account the rated power of the respective grid section are chosen for the grid sections. As such, it may be useful for example to set up the first grid section for a specific number of wind power installations as a radial network and to set up the first grid section for another number of wind power installations as a ring network.

In one example, the first grid section and/or the second grid section and/or the grid converter have/has further connections for electrical means that are configured to stabilize the first grid section and/or the second grid section, and in one example the first system voltage and/or the second system voltage and/or the first system frequency and/or the second system frequency and/or the grid converter.

The connections may be formed for example by cables and/or lines and/or transformers and/or converters and/or circuit breakers and/or the like.

The connections are in one example configured to connect electrical means to the electrical grid, that is to say the first grid section or the second grid section or the grid converter, for example a grid sensor, a grid former, a rotating mass, an electrical store, a fuel cell, a load or the like. In one example, the electrical means are in the form described below.

The present disclosure furthermore proposes a hybrid power plant, or a hybrid plant, comprising an electrical grid as described herein, at least one wind power installation connected to the first grid section, and at least one gas production installation connected to the first grid section and to the second grid section.

The at least one wind power installation may be of any desired type. In one example, the wind power installation is as described herein and/or shown in FIG. 1.

In one example, the wind power installation is configured, for example by means of a full converter, to be operated in a stable manner on a first grid section described herein, and in one example even if the system frequency and/or the system voltage fluctuates (sharply).

In one example, the hybrid power plant has a multiplicity of wind power installations connected to the first grid section. In one example, none of the wind power installations is connected to the second grid section. The multiplicity of wind power installations is, in one example, in the form of a functional unit. The hybrid power plant thus comprises for example ten, twenty, fifty or more wind power installations, which are in one example in the form of, or operated as, a functional unit, such as a windfarm. In one example, the wind power installations of the hybrid power plant have a rated power of at least 100 MW or more in total.

In one example, the multiplicity of wind power installations have a superordinate control unit for this purpose, such as a farm control unit. The superordinate control unit, or the farm control unit, can be configured to control the electrical power generated by the multiplicity of wind power installations, for example by way of specifications and/or setpoint values for the individual wind power installations, or the wind power installation control units thereof. The superordinate control unit, or the farm control unit, controls the electrical power generated by the wind power installations such that the voltage and/or the frequency in the first grid section is substantially stable.

In one example, each of the wind power installations is connected to the first grid section via a transformer, such as in one example, a wind power installation transformer.

In one example, the isolated hybrid power plant furthermore has at least one gas production installation. The at least one gas production installation is connected both to the first grid section and to the second grid section and is controlled for example by means of a gas production installation control unit. The gas production installation, in one example, draws power via a transformer and/or a rectifier connected to the first grid section, in order to, in one example, convert the electrical power generated by the wind power installations into gas by means of an electrolyzer. Moreover, the gas production installation is also connected to the second grid section, in order to supply, in on example, the control systems of the gas production installation with a stable voltage.

In one example, the multiplicity of wind power installations have a higher rated power than the at least one gas production installation. In one example, the rated power of the multiplicity of wind power installations is between 0 and 10 percent higher than the rated power of the at least one gas production installation.

In one example, each of the wind power installations is connected to the first grid section via an inverter and/or a transformer. Alternatively or additionally, the gas production installation is connected to the first grid section via a rectifier and/or a transformer. There may also be provision for further circuit breakers and/or protective switches in order to make the connection between the first grid section and the wind power installations, or the gas production installation.

In one example, the at least one gas production installation has voltage-and/or frequency-sensitive auxiliary devices connected to the second grid section.

The voltage-and/or frequency-sensitive auxiliary devices of the gas production installation are thus connected to the second grid section, in one example while the gas production installation is actually drawing power to produce gas via the first grid section.

The voltage- and/or frequency-sensitive auxiliary devices are intended to be understood to mean, in one example, the electrical auxiliary devices of the gas production installations, which react sensitively to changes of voltage and/or frequency, for example the measurement and/or warning systems of the gas production installations. The voltage- and/or frequency-sensitive auxiliary devices are in one example the electrical means of the control systems of a gas production installation, for example control units, computers, gas warning systems and the like. The voltage-and/or frequency-sensitive auxiliary devices are thus in one example not directly but rather only indirectly involved in gas production. In one example, the hybrid power plant is in the form of a power-to-gas plant or in the form of a power-to-liquid plant or power-to-fuel plant. The hybrid power plant may also be in the form of another P2X plant.

In one example, the hybrid power plant is electrically independent and/or is an isolated hybrid power plant.

An isolated hybrid power plant is understood herein to mean in one example a hybrid power plant and/or a hybrid installation whose electrical grid is not connected to another electrical grid, such as an electrical supply grid.

Nevertheless, the electrical grid can have other electrical subsystems, for example an electrical grid section for gas-processing operations, for example a harbor for shipping the gas produced by the hybrid power plant or the like.

The isolated hybrid power plant can therefore also be referred to as a grid-isolated hybrid power plant. In one example, the electrical grid of the isolated hybrid power plant has no electrical connection to another electrical grid, in one example of higher power.

In one example, the hybrid power plant has a multiplicity of wind power installations that have a total rated electrical power of at least 50 MW, or at least 80 MW, or at least 100 MW, or at least 500 MW. In other embodiments, the hybrid power plant may also have 1 GW or more.

The total rated power of the wind power installations is, in one example, between 0 and 10 percent above the total rated power of the gas production installations. The hybrid power plant is thus electrically over dimensioned and could theoretically generate more electrical power with the wind power installations than the gas production installations can convert into gas.

In one example, the at least one gas production installation is configured to produce hydrogen by means of electrolysis and/or by means of an electrolyzer using electrical energy from the first grid section.

An electrolyzer denotes in one example an apparatus in which electric current is used to bring about a chemical reaction, that is to say a transformation of material, as result of which electrolysis takes place. In one example, the electrolyzer has a polymer electrolyte membrane. The electrolyzer is thus, in one example, in the form of a PEM electrolyzer.

Electrolysis refers to a chemical process in which electric current forces a redox reaction, for example in order to produce gas. In one example, a DC voltage source is used for this purpose.

In one example, the at least one gas production installation is configured to synthesize the hydrogen to produce another gas or a fluid or a fuel, which in one example can be from the list comprising: methane; kerosene; E-fuel; synthetic diesel; synthetic hydrocarbons; ammonia; fertilizers and precursors thereof.

In one example, the hybrid power plant furthermore comprises a grid sensor and/or grid former and/or a rotating mass and/or other electrical means.

In one example, the grid sensor and/or the grid former and/or the rotating mass and/or the other electrical means are connected to the first grid section and/or to the second grid section.

The first grid section and/or the second grid section are thus in one example configured so that at least a grid sensor and/or a grid former and/or a rotating mass can be connected thereto. The first grid section and/or the second grid section thus has in one example at least one connection to which a grid sensor and/or a grid former and/or a rotating mass can be connected. In one example, the connection comprises at least one circuit breaker and/or a transformer and/or a converter, in order to connect the grid sensor and/or the grid former and/or the rotating mass to the first grid section and/or the second grid section.

The grid former is in one example in the form of a voltage-impressing, such as AC-voltage-impressing, energy source, for example in the form of a gas or gas-and-steam turbine with a connected synchronous generator.

The other electrical means are in one example electrical means as described herein, for example an electrical store, an electrical store with a voltage-impressing converter, a fuel cell or the like.

The electrical store is, in one example, in the form of an electrical energy storage system and comprises at least one battery store that in one example can be connected, or is connected, to the second grid section via a voltage-impressing converter.

The fuel cell is, in one example, configured to produce electrical energy from the gas of the gas production installations, to deliver said electrical energy for the second grid section. In one example, the fuel cell produces a DC current from the gas, said DC current, in one example, being converted into an AC current via a converter and thus provided to the second grid section.

In one example, the hybrid power plant has a hybrid power plant control unit that is configured to control the hybrid power plant and/or to carry out and/or participate in a method described herein.

The hybrid power plant control unit is, in one example, connected to a farm control unit and/or a gas production installation control unit in order to carry out a method described herein. In another embodiment, the hybrid power plant control unit, the farm control unit and the gas production installation control unit may also be accommodated in a single control unit.

Alternatively or additionally, the hybrid power plant has a farm control unit that is configured to control a multiplicity of wind power installations and/or to carry out a method described herein.

Alternatively or additionally, the hybrid power plant has a gas production installation control unit that is configured to control the at least one gas production installation.

In one example, the hybrid power plant control unit and/or the farm control unit and/or the gas production installation control unit is configured to regulate the first system frequency by means of the multiplicity of wind power installations and/or the at least one gas production installation such that the first system frequency varies within the first frequency range.

Alternatively or additionally, the hybrid power plant control unit and/or the farm control unit and/or the gas production installation control unit is configured to regulate the first system voltage and/or the second system voltage, and in one example such that the first system voltage substantially corresponds to the first system rated voltage and/or such that the second system voltage substantially corresponds to the second system rated voltage.

Alternatively or additionally, the hybrid power plant control unit and/or the farm control unit and/or the gas production installation control unit is configured to keep the second system frequency stable.

Alternatively or additionally, the hybrid power plant control unit and/or the farm control unit and/or the gas production installation control unit is configured to carry out a method described herein.

In one example, the hybrid power plant control unit and/or the farm control unit has a performance optimization system, such as an MPP tracker and/or a wind measurement system, for the multiplicity of wind power installations, in order to generate a maximum electrical power with the wind power installations.

It is thus in one example proposed that the wind power installations are operated in a manner optimized for performance, for example by using an MPP tracker and/or a wind measurement system.

Additionally or alternatively, the hybrid power plant control unit and/or the gas production installation control unit has a frequency measurement system that measures the system frequency of the first grid section and tracks the power drawn by the gas production installation from the first grid section to a power generated by the wind power installations, in order to keep the system frequency in the first frequency range.

It is thus furthermore also proposed that the electrical power drawn by the gas production installations is tracked to the power generated by the wind power installations.

In a more preferred embodiment, the wind power installations are operated with first statics and the gas production installations are operated with second statics, wherein the first statics and the second statics are contrary.

It is thus in one example proposed that the power output by the wind power installations and the power drawn by the gas production installation behave in a contrary manner, such that a power equilibrium is obtained within the first grid section.

In one example, the statics are frequency/real power statics or voltage/reactive power statics.

In one example, the hybrid power plant control unit is configured to control the hybrid power plant in such a way that the first grid section and/or the second grid section have/has and/or adhere/s to a predetermined frequency quality.

The frequency quality can be determined for example by using an indicator, such as a probability density function of the system frequency or the like. A predetermined limit value is specified for this indicator, and if the indicator is above the predetermined limit value, no further measures are taken. If, on the other hand, the indicator is below the predetermined limit value, further measures are taken. A measure may be for example changing the statics described herein and/or activating specific operating modes for the hybrid power plant. The predetermined limit value for the frequency quality is approximately 10²/2000 mHz.

In one example, the hybrid power plant is designed or dimensioned at least in consideration of one of the following criteria: a gust of wind, such as a 50-year gust; no wind; a fault in a wind power installation that in one example leads to a power dip of 5 percent or more; a fault in a gas production installation that in one example leads to a power dip of up to 25 percent; a fault in an electrical store arranged in the first grid section and/or in the second grid section; and/or a ground fault or short circuit in the electrical grid, and in one example in the first grid section of the electrical grid.

It is thus in one example also proposed that the hybrid power plant is dimensioned in consideration of the electrical behavior, or from a system point of view, and not, as customarily, exclusively in consideration of economic factors.

The present disclosure furthermore proposes a method for controlling a hybrid power plant, as described herein. The method for controlling the hybrid power plant comprises the steps of: measuring an available wind power, in one example by way of a hybrid power plant control unit and/or a farm control unit; specifying a setpoint value, on the basis of the available wind power, for generating an electrical real power by means of a multiplicity of wind power installations, in one example by way of a, or the, hybrid power plant control unit and/or a, or the, farm control unit; measuring a system frequency in an electrical grid or in a grid section of the hybrid power plant, in one example by way of a, or the, hybrid power plant control unit and/or a gas production installation control unit; and specifying a setpoint value, on the basis of the measured system frequency, for drawing a further electrical real power by means of at least one gas production installation, and in one example, by way of a, or the, hybrid power plant control unit and/or a gas production installation control unit, such that the electrical power drawn by the at least one gas production installation substantially corresponds to the electrical power generated by the multiplicity of wind power installations.

The wind power installations and the gas production installations are, in one example, arranged on one and the same grid section and dimensioned for gas production. This in one example also means that substantially all of the electrical power generated by the wind power installations is tapped by the gas production installations and converted into gas.

In one example, the wind power installations take a prevailing wind as a basis for generating a maximum possible power, such as real power. The gas production installations are tracked to this generated power by means of closed-loop frequency/real power control. In one example, the open-loop control, or closed-loop control, of the gas production installations is effected such that a power equilibrium predominates in the first, grid section.

It is thus in one example also proposed that primarily the wind power installations within the hybrid power plant undergo closed-loop control and that the gas production installations match their gas production to the power generated by the wind power installations, for example by means of closed-loop frequency/real power control that measures the system frequency in the grid section between the wind power installations and the gas production installation.

In one embodiment of the hybrid power plant, the wind power installations thus use an MPP tracker, for example, to generate a maximum possible power and the gas production installations regulate their tapped power in consideration of the power generated by the wind power installations, such that the system frequency substantially corresponds to the system rated frequency, or is within the first frequency range.

In another embodiment of the hybrid power plant, the closed-loop control of the hybrid power plant, that is to say in one example the closed-loop control of the power generation and power tapping, is undertaken by a hybrid power plant control unit that is superordinate to the farm control unit and the gas production installation control unit, for example.

In one example, the method for controlling a hybrid power plant furthermore comprises the steps of: measuring a system frequency and/or a system voltage in a grid section; and specifying setpoint values, such as power setpoint values, to a grid converter, in order to stabilize a voltage and/or a frequency in a first or a second grid section connected to the grid converter.

The setpoint values for the grid converter are, in one example, specified by a hybrid power plant control unit. The grid converter is as described herein and/or configured to stabilize a frequency and/or a voltage.

In one example, the method for controlling a hybrid power plant furthermore comprises the step of: adapting statics for wind power installations and/or gas production installations, in one example on the basis of a measured system frequency and/or a measured system voltage.

In another exemplary embodiment, the wind power installations and/or the gas production installations are controlled by means of statics, for example, and/or the statics are appropriately matched to the system frequency, or the system voltage.

In one example, the setpoint values, such as the power setpoint values, are specified in consideration of a frequency quality and/or voltage quality.

It is thus in one example proposed that the system frequency and/or the system voltage are/is measured and rated, for example by way of an indicator and/or a statistical tool, such as a probability density function.

The setpoint values are then specified in consideration of this rating, or the quality. If the quality of the frequency and/or the voltage is above average, the setpoint values can be chosen to be more dynamic, for example. If the quality of the frequency and/or the voltage is below average, the setpoint values can be chosen to be more static, for example. Such specification of setpoint values allows, in one example, the hybrid power plant to be operated more dynamically without the hybrid power plant becoming unstable from an electrical or system point of view. Such an approach allows more electrical power and therefore also more gas to be produced.

In one example, the method for controlling a hybrid power plant furthermore comprises the step of: measuring a system voltage and/or a system frequency in another grid section; and adjusting a real power and/or reactive power to be supplied on the basis of the measured system voltage and/or system frequency at an electrical store that is in one example configured to operate in a voltage-impressing manner on the other grid section.

In one example, the power generated by the wind power installations is temporarily reduced until the power extracted by the gas production installation corresponds to the power generated by the wind power installations, such as when a gust of wind occurs and/or the system frequency leaves a frequency range.

Alternatively or additionally, the power drawn by the gas production installation is reduced until the power generated by the wind power installations corresponds to the power extracted by the gas production installation, in one example when there is a lull in the wind and/or the system frequency leaves a frequency range.

Thus, in one example, a frequency range is specified for the system frequency, and only when the system frequency leaves this frequency range is action actively taken in the closed-loop power control of the wind power installations and/or the gas production installations. This is shown by way of example in FIG. 3.

In one example, the method for controlling a hybrid power plant furthermore comprises the step of: switching off and/or shutting down the hybrid power plant, in one example such that the first grid section is de-energized when a gas alarm is triggered in the gas production installation; and/or a ground fault and/or short circuit occurs in the grid section; and/or the efficiency of the gas production installation falls, in one example abruptly, below 75 percent.

The efficiency of the gas production installations can fall below 75 percent, for example, because multiple electrolyzers fail. This in turn may have various reasons, for example damage to the electrolyzers or electrical faults in the other, in one example second, grid section.

The present disclosure furthermore proposes a wind power installation that has an electrical generator having an electrical stator and an electrical rotor, and a converter configured to be operated in a stable manner on a grid section of an electrical grid, wherein the grid section has a system frequency that fluctuates around the system rated frequency by up to +/−10 Hz in one example, preferably +/−7 Hz in another example, and/or preferably +/−3 Hz in another example.

The wind power installation thus, in one example, has a converter, such as a power converter, that may be in the form of a full converter and can be operated in a stable manner on a grid section that has a sharply fluctuating frequency. The converter is thus in one example configured to be operated on a first grid section of an electrical grid of a hybrid power plant, as described herein. The converter thus has a particular system-specific control range, in one example, a large system-specific control range. This can be achieved for example as a result of the converter being equipped with appropriate power electronics and/or with an appropriate converter control unit having relevant control programs and/or operating modes.

Alternatively or additionally, the converter of the wind power installation is designed for wide voltage fluctuations in the electrical grid, or in the grid section.

In one example, the wind power installation has a rated power of between 2 MW and 10 MW.

In one example, the converter is configured to be operated in a stable manner on a grid section having a frequency quality of 10²/2000 mHz or better.

The converter is thus in one example configured to be operated on a grid section that has a wide operating frequency range, or for which the system frequency is extremely volatile, or fluctuates sharply.

In one example, the converter has at least one FRT mode, in which the wind power installation is connected to a grid section and supplies no electrical power, even if the grid section has a system voltage that is less than 80 percent of the system rated voltage.

In one example, the wind power installation furthermore has a wind power installation transformer that connects the converter to a first grid section, as described herein.

The devices, assemblies and components described herein are intended to be understood in some examples as electrical devices, assemblies and components that, insofar as they are described as being connected to one another, are electrically conductively connected to one another. Thus, a relevant electric current flows, or there is relevant transportation of electrical power, between the individual devices, assemblies and components.

### BRIEF DESCRIPTION OF THE SEVERAL VIEWS OF THE DRAWINGS

The present disclosure is outlined in more detail below with reference to the accompanying figures, wherein the same reference signs are used for identical or similar devices or assemblies.

FIG. 1A schematically shows a perspective view of a wind power installation in one embodiment by way of example.

FIG. 1B schematically shows a design of an electrical phase section of a wind power installation in one embodiment by way of example.

FIG. 2 schematically shows a design of an isolated hybrid power plant in one embodiment by way of example.

FIG. 3 schematically shows open-loop frequency/power control of a hybrid power plant by way of example.

### DETAILED DESCRIPTION

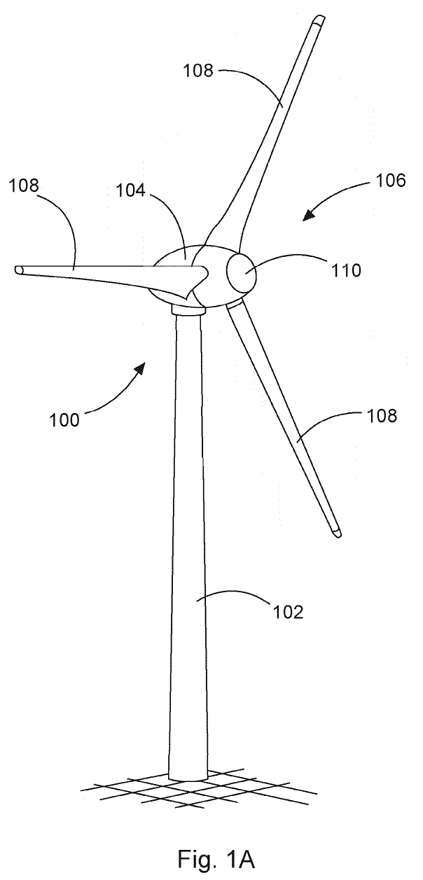

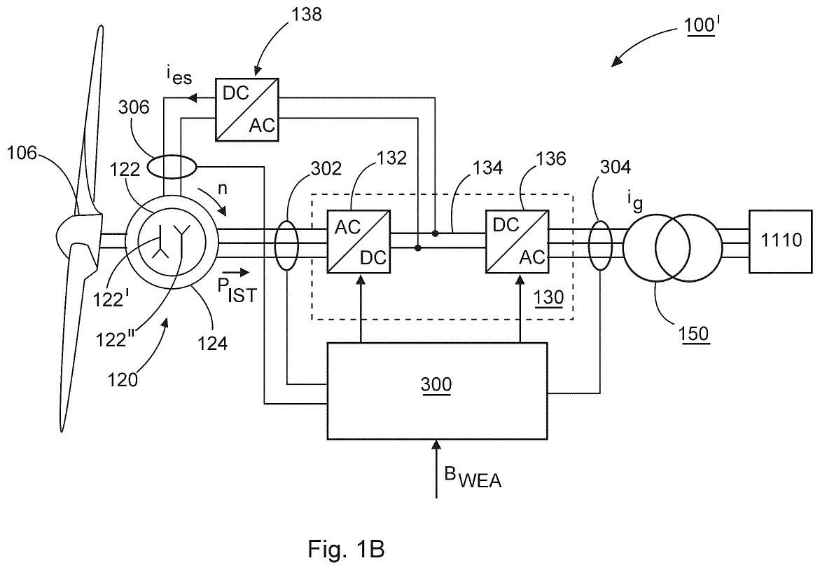

FIG. 1A schematically shows a perspective view of a wind power installation 100 by way of example.

The wind power installation 100 has a tower 102 and a nacelle 104.

An aerodynamic rotor 106 having three rotor blades 108 on a hub 110 is arranged on the nacelle 104.

The three rotor blades 108 are, in one example, arranged symmetrically with respect to the hub 110, and in one example, in a manner offset from one another by 120°.

The wind power installation 100 is, in one example, in the form of a buoyancy rotor having a horizontal axis and three rotor blades 108 on the windward side, in one example in the form of a horizontal rotor.

FIG. 1B schematically shows an electrical phase section 100′ of a wind power installation 100 by way of example, as shown in FIG. 1A.

The wind power installation 100 has an aerodynamic rotor 106 mechanically connected to a generator 120 of the wind power installation 100. The aerodynamic rotor 106 is set in rotational motion by a wind and thus drives the generator 120.

The generator 120 has an electrical stator 122 and an electrical rotor 124. In one example, the generator 120 is in the form of a 6-phase and/or separately excited synchronous generator, in one example having two three-phase stator systems 122′, 122″, which are phase-shifted through 30 degrees and electrically decoupled from one another.

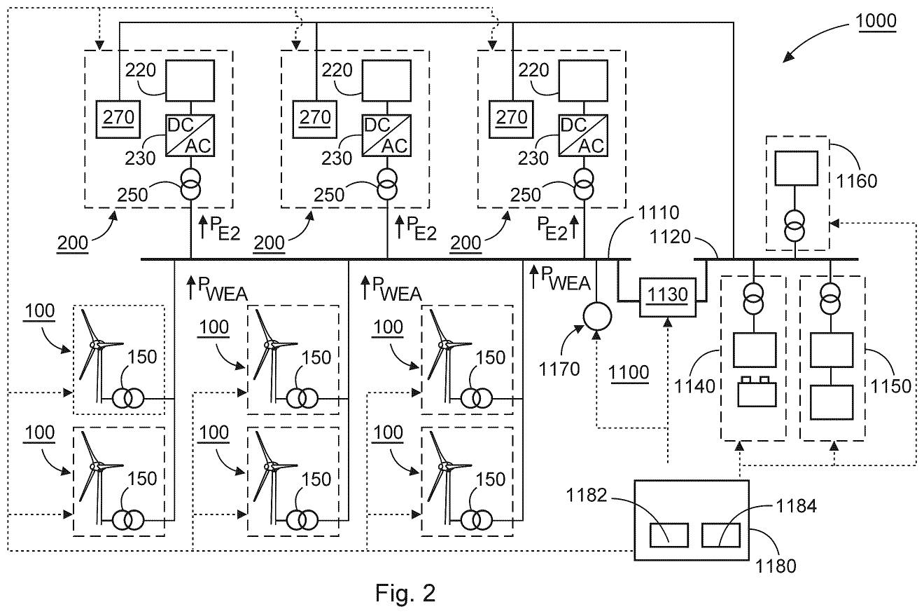

The generator 120 is connected to an electrical grid, in one example a first grid section 1110 of an electrical grid 1100 of an isolated hybrid power plant 1000, as in FIG. 2, for example, via a converter 130 and for example a wind power installation transformer 150.

The converter 130 converts the electrical power generated by the generator 120 into a three-phase AC current ig to be supplied. For this purpose, the converter 130 is, in one example, in the form of a converter system, i.e. the converter has multiple converter modules, which may be interconnected with one another in parallel.

The converter 130 comprises a rectifier 132, in one example an active rectifier, optionally a DC link 134 and an inverter 136. In one example, the converter 130, or the converter modules, is/are (a) back-to-back converter/s.

Moreover, the converter 130, in one example the DC link 134, provides an excitation 138 that uses an excitation current ies to separately excite the generator 120.

The converter 130 is controlled by means of a control unit 140. The control unit 140 can also be referred to as a converter control unit. In one example, the control unit 140 is connected to a wind power installation control unit and/or a grid operator, in order to receive setpoint specifications Bwea, for example for the current ig to be supplied or the power to be generated.

FIG. 2 schematically shows a design of an isolated hybrid power plant 1000 in one embodiment by way of example.

The isolated hybrid power plant 1000 comprises an electrical grid 1100, a multiplicity of wind power installations 100 and multiple gas production installations 200.

The electrical grid 1100 has a first grid section 1110 and a second grid section 1120, which are connected to one another via a grid converter 1130.

The first grid section 1110 has the multiplicity of wind power installations 100 and the multiple gas production installations 200 connected to it. Furthermore, the first grid section has a rotating mass 1170.

The wind power installations 100 are in the form described herein and in one example connected to the first grid section 1110 via a wind power installation transformer 150. In one example, each wind power installation 100 moreover has a wind power installation control unit.

The gas production installations 200 are in the form described herein and in one example connected to the first grid section 1110 via a gas production installation transformer 250 and an active rectifier 230. The gas producer 220, in one example an electrolyzer, obtains the necessary electrical power from the first grid section 1110 via the gas production installation transformer 250 and a rectifier 230. The frequency-and voltage-sensitive auxiliary devices 270 of the gas production installations 200 are furthermore connected to the second grid section 1120.

The rotating mass 1170 is used by the first grid section in one example as a grid sensor. The rotating mass 1170 thus in one example impresses into the first grid section a voltage to which the wind power installations 100 can synchronize themselves. The rotating mass 1170 is formed for example from a gas turbine with a synchronous generator or from an electrical store with a virtual synchronous machine.

The second grid section 1120 has an electrical store 1140, in one example a battery energy storage system (BESS for short) with a voltage-impressing converter, a fuel cell 1150 with a voltage-impressing converter, an electrical load 1160, and the frequency-and voltage-sensitive auxiliary devices 270 of the gas production installations connected to it.

The electrical load 1160 is for example an electrical grid of a harbor and/or of a gas pipeline, which are able to be supplied with power by means of the second grid section, such that the gas can be transported away.

The first grid section 1110 and the second grid section 1120 are furthermore connected via a common grid converter 1130. The grid converter is in one example as described herein.

The hybrid power plant 1000 is controlled by means of a hybrid power plant control unit 1180. The hybrid power plant control unit 1180 comprises for example a farm control unit 1182 and/or a gas production installation control unit 1184 and is configured to control, in one example, all of the electrical means of the hybrid power plant, to control them by means of setpoint values.

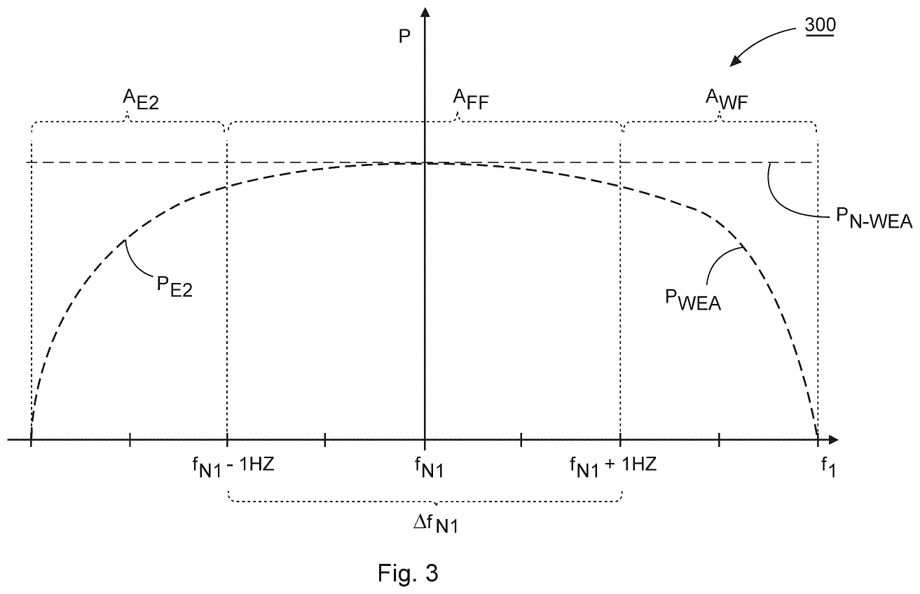

FIG. 3 schematically shows open-loop frequency/power control 300 of a hybrid power plant 1000 by way of example, on the basis of a coordinate system, wherein the system frequency f1 is plotted on the x axis of the coordinate system and the electrical power P is plotted on the y axis of the coordinate system.

To improve understanding, the rated power PN_wea of the wind power installations is also shown in the coordinate system.

While the system frequency f1 is within the first frequency range ΔfN1, which is +/−1 Hz, for example, substantially no control action is taken within the first grid section, and the hybrid power plant operates in a first operating range AFF, in which the system frequency f1 varies substantially freely (free-floating system frequency).

If, for example due to a strong gust, there is now an increase in the generation of electrical power P by the wind power installations and, as a result, an increase in the system frequency f1, then, if the system frequency f1 moves outside the frequency range ΔfN1, closed-loop control of the wind power installations can be undertaken. By way of example, the electrical power generated by the wind power installations is then actively restricted, in one example until the power extracted by the gas production installation corresponds to the power generated by the wind power installations. This is identified by the second operating range AWF.

If, for example due to there being no wind, there is now a decrease in the generation of electrical power P by the wind power installations and, as a result, a decrease in the system frequency f1, then, if the system frequency f1 moves outside the frequency range ΔfN1, closed-loop control of the gas production installations can be undertaken. By way of example, the electrical power tapped by the gas production installations is actively restricted, in until the power generated by the wind power installations corresponds to the power extracted by the gas production installation, and in one example in the event of a lull in the wind.

### LIST OF REFERENCE SIGNS

100 wind power installation
100′ electrical phase section, in one example of the wind power installation
102 tower, in one example of the wind power installation
104 nacelle, in one example of the wind power installation
106 aerodynamic rotor, in one example of the wind power installation
108 rotor blade, in one example of the wind power installation
110 hub, in one example of the wind power installation
120 generator, in one example of the wind power installation
122 stator, in one example electrical stator of the generator
122′ first electrical system, in one example of the stator
122″ second electrical system, in one example of the stator
124 rotor, in one example electrical rotor of the generator
130 converter, in one example power converter of the wind power installation
150 transformer, in one example the wind power installation transformer
200 gas production installation
220 gas producer, in one example electrolyzer
230 converter, in one example rectifier of the gas production installation
250 transformer, in one example of the gas production installation
300 frequency-power control, in one example of a hybrid power plant
1000 isolated hybrid power plant
1100 electrical grid
1110 first grid section, in one example of the electrical supply grid
1120 second grid section, in one example of the electrical supply grid
1130 grid converter, in one example of the electrical distribution grid
1140 electrical energy store
1150 fuel cell, in one example with voltage-impressing converter
1160 electrical load
1170 rotating mass
1180 control unit, in one example of the hybrid power plant
1182 control unit, in one example of the wind power installations
1184 control unit, in one example of the gas production installations
fN1 first system rated frequency, in one example of the first grid section
fN2 second system rated frequency, in one example of the second grid section
f1 first system frequency, in one example of the first grid section
f2 second system frequency, in one example of the second grid section
S1 first system statics, in one example of the first grid section
S2 second system statics, in one example of the second grid section
UN1 first system rated voltage, in one example of the first grid section
UN2 second system rated voltage, in one example of the second grid section
U1 first system voltage, in one example of the first grid section
U2 second system voltage, in one example of the second grid section
ΔfN1 first frequency range, in one example of the first grid section
PN_wea rated power, in one example of the wind power installations
P_wea electrical power generated by the wind power installation
P_E2_electrical power tapped by the gas production installation
A_{FF} first operating range, in one example free-floating
A_{WF} second operating range, in one example reduction of the generated power.

1. An electrical grid for an isolated hybrid power plant, comprising:
a first grid section configured to:
be connected to at least one wind power installation,
be connected to at least one gas production installation, and
transport an electrical power generated by the wind power installation to the at least one gas production installation;
a second grid section, configured to:
be connected to the at least one gas production installation; and
a grid converter configured to:
electrically connect the first grid section and the second grid section to one another and
bidirectionally exchange electrical power between the first electrical grid section and the second electrical grid section wherein
the first grid section has a first system rated frequency (fN1) and a first system rated voltage (UN1) and is configured to be operated at a first system frequency (f1) and a first system voltage (U1);
the second grid section has a second system rated frequency (fN2) and a second system rated voltage (UN2) and is configured to be operated at a second system frequency (f2) and a second system voltage (U2);
the first grid section is designed for a first frequency range (Δf1) around the system rated frequency (fN1), in which the first system frequency (f1) varies;
the second grid section is designed for a second frequency range (Δf2) around the system rated frequency (fN2), in which the second system frequency (f2) varies; and
the first frequency range (Δf1) is higher than the second frequency range (Δf2).

2. The electrical grid as claimed in claim 1, wherein
the first grid section has a first rated power (P_Nenn_1) and
the second grid section has a second rated power (P_Nenn_2), wherein
the first rated power (P_Nenn_1) is higher than the second rated power (P_Nenn_2), by at least one of a factor of 5 or a factor of 10.

3. The electrical grid as claimed in claim 1, wherein
the first frequency range (Δf1) is equal to or less than one of 20 percent or 10 percent of the first system rated frequency (fN1); and/or p1 the second frequency range (Δf2) is equal to or less than one of 2 percent or 1 percent of the second system rated frequency (fN2).

4. The electrical grid as claimed in claim 1, wherein
the second grid section is configured to supply at least one of voltage-sensitive or frequency-sensitive auxiliary devices, with electrical power in at least one of a voltage-stable or a frequency-stable manner.

5. The electrical grid as claimed in claim 1, wherein the grid converter is configured to:
exchange, bidirectionally, electrical power between the first grid section and the second grid section;
form a grid former or a regulated current source for the first grid section or the second grid section;
stabilize the system voltage or the system frequency in the first grid section or in the second grid section;
deliver at least one of a stable second system frequency (f2) or a stable second system voltage (U2) in the second grid section for at least one of voltage-sensitive or frequency-sensitive auxiliary devices;
impress a system voltage (U2) into at least one of the first grid section or the second grid section;
deliver a short-circuit power for at least one of the first grid section or the second grid section, if a disturbance occurs in the first grid section or in the second grid section;
deliver a real power and a reactive power for the at least one of the first grid section or the second grid section without any delay.

6. The electrical grid as claimed in claim 1, wherein at least one of:
the electrical grid is electrically independent or isolated;
the electrical grid is connected exclusively to other electrical grids that have at least one of a lower system rated power or a system rated voltage;
the electrical grid is not connected to an electrical supply grid or interconnected system or to another electrical distribution grid that has the same or a higher system rated power or a system rated voltage compared to the first grid section or the second grid section; or
the first grid section is not connected to another electrical distribution grid or to an electrical supply grid or to interconnected system.

7. A hybrid power plant comprising:
an electrical distribution grid as claimed in claim 1,
a plurality of wind power installations connected to the first grid section, and
at least one gas production installation connected to the first grid section and to the second grid section.

8. The hybrid power plant as claimed in claim 7, wherein at least one of:
each of the wind power installations is connected to the first grid section via at least one of an inverter or a transformer, or
the gas production installation is connected to the first grid section via at least one of a rectifier or a transformer.

9. The hybrid power plant as claimed in claim 7, wherein
the gas production installation has at least one of voltage-sensitive auxiliary devices or frequency-sensitive auxiliary devices that are connected to the second grid section.

10. The hybrid power plant as claimed in claim 7, wherein
the hybrid power plant is in the form of a power-to-gas plant or in the form of a power-to-liquid plant or power-to-fuel plant, and
the hybrid power plant is electrically independent or is an isolated hybrid power plant.

11. The hybrid power plant as claimed in claim 1, comprising:
at least one of a grid sensor, a grid former, rotating mass, or other electrical components.

12. The hybrid power plant as claimed in claim 7, furthermore comprising:
a hybrid power plant control unit configured to control the hybrid power plant;
a farm control unit configured to control the multiplicity of wind power installations; and
a gas production installation control unit configured to control the at least one gas production installation.

13. The hybrid power plant as claimed in claim 12, wherein
the hybrid power plant control unit, the farm control unit, and the gas production installation control unit are configured to:
regulate the first system frequency (f1) by the plurality of wind power installations or the at least one gas production installation such that the first system frequency (f1) varies within the first frequency range (Δf1);
regulate the first system voltage (U1) or the second system voltage (U2); and
keep the second system frequency (f2) stable.

14. The hybrid power plant as claimed in claim 12, wherein
at least one of the hybrid power plant control unit or the farm control unit has a performance optimization system for the plurality of wind power installations, in order to generate a maximum electrical power with the plurality of wind power installations, and
at least one of the hybrid power plant control unit or the gas production installation control unit has a frequency measurement system configured to measure the system frequency (f1) of the first grid section and tracks the power drawn by the gas production installation from the first grid section to a power generated by the plurality of wind power installations in order to keep the system frequency (f1) in the first frequency range (Δf1).

15. The hybrid power plant as claimed in claim 12, wherein
at least one of the hybrid power plant control unit or the farm control unit has first statics (Swea),
at least one of the hybrid power plant control unit or the gas production installation control unit has second statics (Sgas), wherein
the first statics and the second statics are contrary.

16. The hybrid power plant as claimed in claim 12, wherein
the hybrid power plant control unit is configured to control the hybrid power plant in such a way that at least one of the first grid section or the second grid section complies with a predetermined frequency quality.

17. The hybrid power plant as claimed in claim 12, wherein the hybrid power plant has been dimensioned at least in consideration of one of:
a gust of wind, wherein the gust is a 50-year gust;
no wind;
a fault in a wind power installation that leads to a power dip of 5 percent or more;
a fault in a gas production installation that leads to a power dip of up to 25 percent;
a fault in an electrical store arranged in the first grid section or in the second grid section;
a ground fault or short circuit in the first grid section of the electrical grid.

18. A method for controlling a hybrid power plant, as claimed in claim 7, comprising:
measuring an available wind power, by way of at least one of a hybrid power plant control unit a farm control unit
specifying a setpoint value, on the basis of the available wind power, for generating an electrical real power via the hybrid power plant control unit or the farm control unit;
measuring a system frequency in an electrical grid or in a grid section of the hybrid power plant, via the hybrid power plant control unit or a gas production installation control unit; and
specifying a setpoint value, on the basis of the measured system frequency, for drawing a further electrical real power from at least one gas production installation, via at least one of the hybrid power plant control unit or the gas production installation control unit such that the electrical power drawn by the at least one gas production installation substantially corresponds to the electrical power generated by the plurality of wind power installations.

19. The method for controlling a hybrid power plant as claimed in claim 18, furthermore comprising:
measuring at least one of a system frequency or a system voltage in a grid section; and
specifying setpoint values, to a grid converter; to stabilize at least one of a voltage or a frequency in at least one of a first grid section or a second grid section connected to the grid converter.

20. The method for controlling a hybrid power plant as claimed in claim 18, furthermore comprising:
adapting statics for wind power installations or gas production installations, based on one of a measured system frequency or a measured system voltage.

21. The method for controlling a hybrid power plant as claimed in claim 18,
wherein the setpoint values are specified based on one of a frequency quality or a voltage quality.

22. The method for controlling a hybrid power plant as claimed in claim 18, wherein
the plurality of wind power installations are configured to temporarily reduce the generated electrical power until the power extracted by the gas production installation corresponds to the power generated by the wind power installations when at least one of a gust of wind occurs or the system frequency is outside a frequency range; and
the gas production installation is configured to reduce the tapped electrical power until the power generated by the wind power installations corresponds to the electrical power tapped by the gas production installation when at least one of lull in the wind exists or the system frequency leaves a frequency range.

23. A wind power installation for a hybrid power plant as claimed claim 7, comprising:
an electrical generator having an electrical stator and an electrical rotor, and
a converter configured to be operated in a stable manner on a grid section of an electrical grid, wherein the grid section has a system frequency (f1) that fluctuates around the system rated frequency (fN1) by up to one of +/−10 Hz, +/−7 Hz, or +/−3 Hz.

24. The wind power installation as claimed in claim 23, wherein
the converter is configured to be operated in a stable manner on a grid section having a frequency quality of 10²/2000 mHz or better.

25. The wind power installation as claimed in claim 23, wherein
the converter has at least one FRT mode, in which the wind power installation is connected to a grid section and supplies no electrical power, even if the grid section has a system voltage that is less than 80 percent of the system rated voltage.
